(19) United States
(12) Patent Application Publication
(10) Pub. No.: US 2012/0282506 A1
(43) Pub. Date: Nov. 8, 2012

(54) ELECTROCHEMICAL ENERGY STORE FOR VEHICLES AND METHOD FOR COOLING OR HEATING SUCH AN ELECTROCHEMICAL STORE

(75) Inventors: Claus-Rupert Hohenthanner, Hanau (DE); Claudia Brasse, Meerbusch (DE); Andreas Fuchs, Leipzig (DE); Joerg Kaiser, Eggenstein (DE); Andreas Gutsch, Luedinghausen (DE); Tim Schaefer, Niedersachswerfen (DE)

(73) Assignee: LI-TEC BATTERY GMBH, Kamenz (DE)

(21) Appl. No.: 13/393,195

(22) PCT Filed: Aug. 27, 2010
(86) PCT No.: PCT/EP10/05289

§ 371 Date: Jul. 26, 2012

(30) Foreign Application Priority Data
Sep. 4, 2009 (DE) 10 2009 040 147.4

(51) Int. Cl. H01M 2/10; F28F 7/00

(52) U.S. Cl. 429/99; 165/185

(57) ABSTRACT

An electrochemical energy storage device (1) comprising a casing (2), in which a plurality of flat galvanic cells (3) are arranged. Between two adjacent flat galvanic cells is in each case, a flat heat conducting body (4) and/or a flat elastic body (5) arranged. Preferably, the flat galvanic cells, the flat heat conducting bodies and/or the flat elastic bodies exert upon each other at the contact surface areas, a force (11) corresponding to a surface pressing, and the casing has a wall with a structure or with structures (8, 9), in which a heat conducting body (4) engages such, that said heat conducting body may not be shiftable in the direction of the force (11), acting on the contact surface areas.

The content of the priority application DE 10 2009 040 147.4, filed on Sep. 4, 2009 is herewith incorporated by reference and is part of the description.

The present invention relates to an electrochemical energy storage device for vehicles and a method for cooling or heating such an electrochemical energy storage device, in particular a lithium-ion accumulator. However, the invention may also be used for electrochemical energy storage devices without lithium, and also independently of vehicles.

Various types of electrochemical energy storage devices with galvanic cells for storing electrical energy are known from the prior art. Therein, the electrical energy supplied to such an energy storage device is converted into chemical energy and is stored. This conversion is associated with an energy loss, because, during said conversion, irreversible chemical reactions occur, which cause aging or damaging of the battery. The energy losses that occur are released in the form of heat, which may be associated with a temperature increase of the galvanic cell.

In case the temperature in the galvanic cell increases too much, the danger of destruction of the energy storage device exists, wherein, under certain conditions, said energy storage device may burn or explode. Such undesirable phenomena may be avoided by ensuring a most effective cooling of the electrochemical energy storage device.

On the other hand, many electrochemical energy storage devices only work efficiently or reliably above a minimum operating temperature, which depends on the battery's design and operating principle. Therefore, depending on the intended use or the application of an electrochemical energy storage device, it may be desirable to increase its temperature by applying heat.

In case of using the electrochemical energy storage devices in vehicles, additional requirements are to be considered, which correlate with the forces occurring in the vehicle, for example, inertia forces, which may be transmitted to the battery casing and to the cell. Such forces may cause vibrations of the cells within the battery casing or may cause other undesirable relative movements of galvanic cells within the battery casing.

Similar effects may also occur outside of the context of vehicles, for example, in connection with industrial plants, in which vibrations or shocks may occur.

The present invention has, therefore, the objective, to provide an electrochemical energy storage device, in particular for operation in vehicles, and an effective method for cooling or for heating of such an electrochemical energy storage device.

According to the invention, this is achieved by the subject-matter of the independent claims.

The electrochemical energy storage device according to the invention, has a casing, inside of which a plurality of flat galvanic cells is arranged. A flat heat conducting body and/or a flat elastic body is arranged between two adjacent flat galvanic cells, respectively.

With respect to the present invention, an “electrochemical energy storage device” refers to any kind of energy storage device, from which electrical energy may be extracted, wherein an electrochemical reaction takes place inside the energy storage device. The term comprises, in particular, galvanic cells of all types, in particular, primary cells, secondary cells and assemblies of such cells in the form of batteries of such cells. Such electrochemical energy storage devices typically have negative and positive electrodes, which are separated by a so-called separator. Ion transport between the electrodes takes place as mediated by an electrolyte.

The term “flat physical object”, according to the present invention, refers to an object, which essentially has the shape of a regular prism, whose base and top surfaces are essentially larger than its lateral (side) surfaces. As is common in the field of geometry, a prism refers to a geometric body that has a polygon as its base and whose side edges are, essentially, in parallel, and essentially, equal in length. According to geometry, such a prism is generated by a parallel shift of a planar polygon, along a line in space, which is not in said plane. In case this parallel shift of the polygon is performed perpendicular to the surface area of the polygon, then an regular (“gerade”) prism is formed. The polygon is normally referred to as the base, the other boundary surface area of the prism, which is congruent to and in parallel to the base, is referred to as its to surface area. The totality of all other boundary surface areas, is also referred to as the outer surface area of the prism. In some cases, parts of this outer surface area may also referred to as front surface area(s).

Important examples of such prismatic galvanic cells are so-called pouch cells or so-called coffee-bag cells, which typically, essentially, have the shape of a flat cuboid, often with rounded corners. In such galvanic cells, the prismatic form often refers to the casing or the foil packaging of the cell only, since the electrical contacts for connection, which are often referred to as connectors, protrude through the prismatically shaped casing or from the prismatically shaped packing.

Such flat physical items may be arranged in a space-saving manner, such that they exert a force upon each other, corresponding to surface pressing at their contact surface areas, primarily at their base or deck surface areas.

The term “surface pressing”, generally, refers to a force per area unit, which acts between two solid bodies, wherein said solid bodies touch each other at their surface areas. When two solid bodies are pressed together by a force, a normal load distribution occurs between the bodies at the surface area of contact; this is also referred to as a “surface pressing”. Contrary to pressure, “surface pressing” is, not isotropic, the “surface pressing” has—just like a stress force—one direction, and is not necessarily constant over the (entire) contact surface area. As mediated by the effect of a “surface pressing”, a characteristic stress distribution occurs in the bodies involved.

In accordance with the present invention, the term “heat conducting body” refer to a physical object, which is suitable for conducting heat, in particular for dissipating heat from a body with which it is brought into contact.

The term “elastic body” refers, in accordance with the present invention, to a physical object, which experiences a so-called elastic deformation under the action of an external force. The elastic body thereby exerts a respective counterforce vis-à-vis the external force, which increases with progressing deformation, so that the deformation eventually stops, once an equilibruim of forces is achieved. It is characteristic for elastic bodies that the deformation completely recovers when the external force disappears. In the context of the present invention, an “elastic body” also refers to an “essentially elastic body”, for which the ideal elastic properties of ideal elastic bodies are, at least, approximately fulfilled.

In accordance with the present invention, the term “heat transfer medium” refers to a gaseous or a liquid material, which is suitable, due to its physical properties, to transport heat by means of heat conducting and/or by means of heat transfer due to convection in the heat transfer medium. Important examples of commonly used heat transfer media in the art are, for example, air or water. Depending on the application context, other gases or liquids may also be used, such as chemically inert (less reactive) gases or liquids, such as, for example, noble gases or liquefied noble gases, or materials with high thermal capacity and/or thermal conductivity.

Advantageous embodiments and further developments are the subject-matter of the dependend claims.

A preferred embodiment of the electrochemical energy storage device of the invention is characterized in that the flat galvanic cells, the flat heat conducting bodies and/or the flat elastic bodies, at the contact surface areas, exert a force upon each other corresponding to a surface pressing. By means of such a force, the contact of the contacting surfaces areas and thus, the heat transfer between these surface areas, is regularly improved, because, thereby, small deviations from the ideal planarity of the contact surface areas, may largely be compensated for. This is, in particular, the case when, for example, the casing of a so-called coffee bag cell is formed by a film, which, at sufficient pressure, may easily adjust relative to the deviations from an ideal plane of the surface area of a non-ideal plane, as preferably formed by a contact surface area of a heat conducting body.

A further preferred embodiment of the electrochemical energy storage device of the invention is characterized in that the casing has at least one wall with a structure or with structures, with which at least one heat conducting body engages, such that this heat conducting body cannot be shifted in the direction of the forces, acting on the contact surface areas. In this embodiment, the heat conducting bodies serve, therefore, preferably, at the same time as mounting devices, which ensure, that the forces, occurring in a vehicle, do not result in undesirable shifts of the galvanic cells.

A further preferred embodiment of the electrochemical energy storage device of the present invention is characterized in that the heat conducting bodies are in heat conductive contact with the heat exchange elements, which protrude from the casing. Such heat exchange elements are suitable for improving the heat transfer from the heat conducting body and thus, from the galvanic cell, which ist connected with the evironment via the heat conducting body.

A further preferred embodiment of the electrochemical energy storage device of the invention is characterized in that the heat conducting body is in heat conductive contact with part of the casing parts, which have channels, through which a gaseous or liquid heat transfer medium may flow. Alternatively, or in combination, the electrochemical energy storage device may be equipped with heat conducting bodies, which have channels through which a gaseous or liquid heat transfer medium may flow.

The person skilled in the art will know how to combine some of the described embodiments of the present invention, based on his expert knowledge. Other embodiments, which are not described here conclusively, or in the following description, will be easily determined by the person skilled in the art due to his expert knowledge and on the basis of the present specification. The invention is not limited to the embodiments described herein.

In the following, the invention will be described in more detail based on preferred embodiments and with the aid of figures:

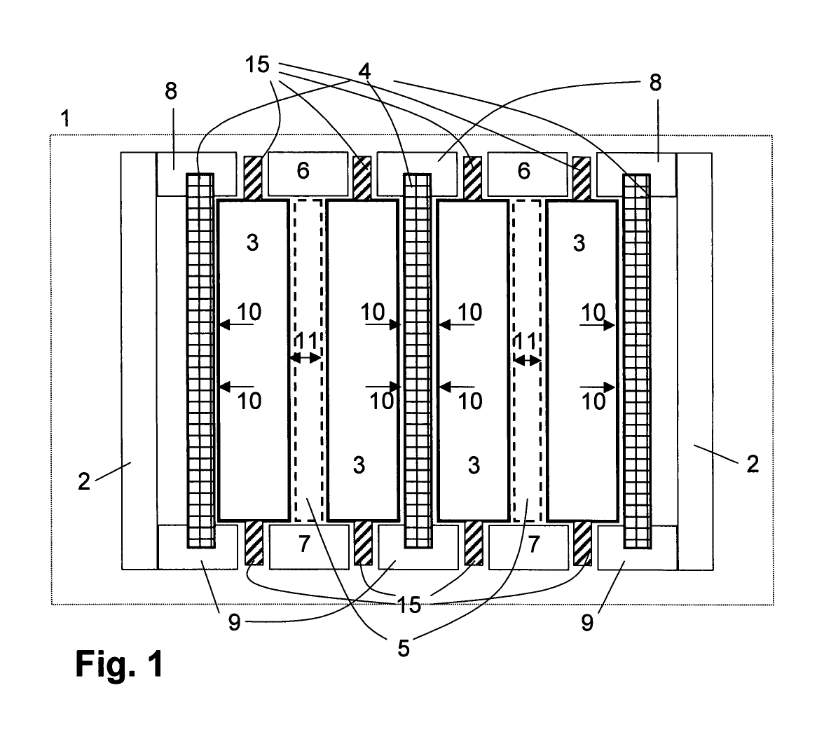

FIG. 1 shows an electrochemical energy storage device according to the invention and according to a first embodiment of the invention;

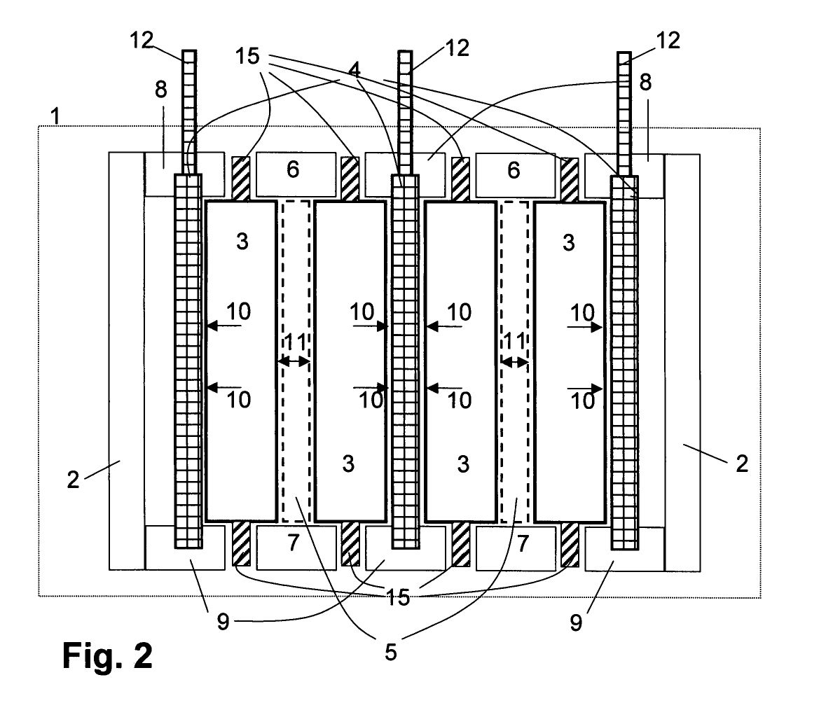

FIG. 2 shows an electrochemical energy storage device according to the invention and according to a second embodiment of the invention with heat exchange elements on the heat conducting bodies;

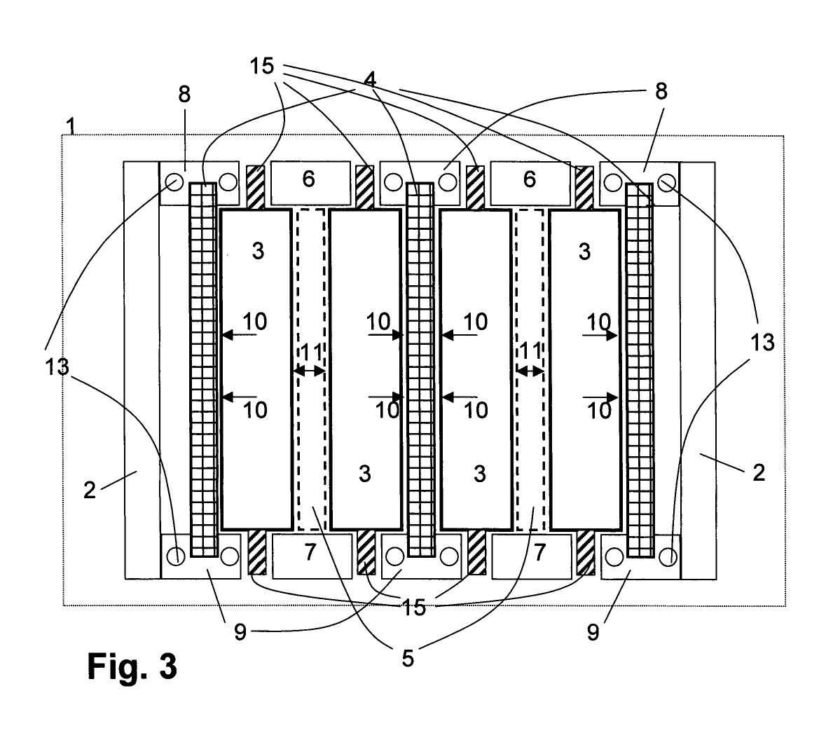

FIG. 3 shows an electrochemical energy storage device according to the invention and according to a third embodiment of the invention with channels in the casing;

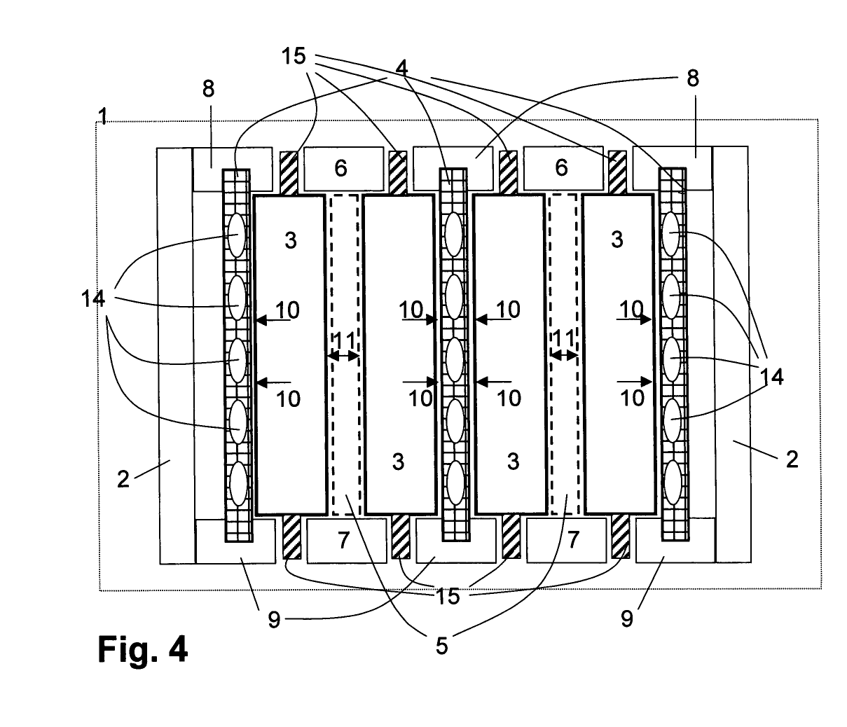

FIG. 4 shows an electrochemical energy storage device according to the invention and according to a fourth embodiment of the invention with channels in the heat conducting bodies;

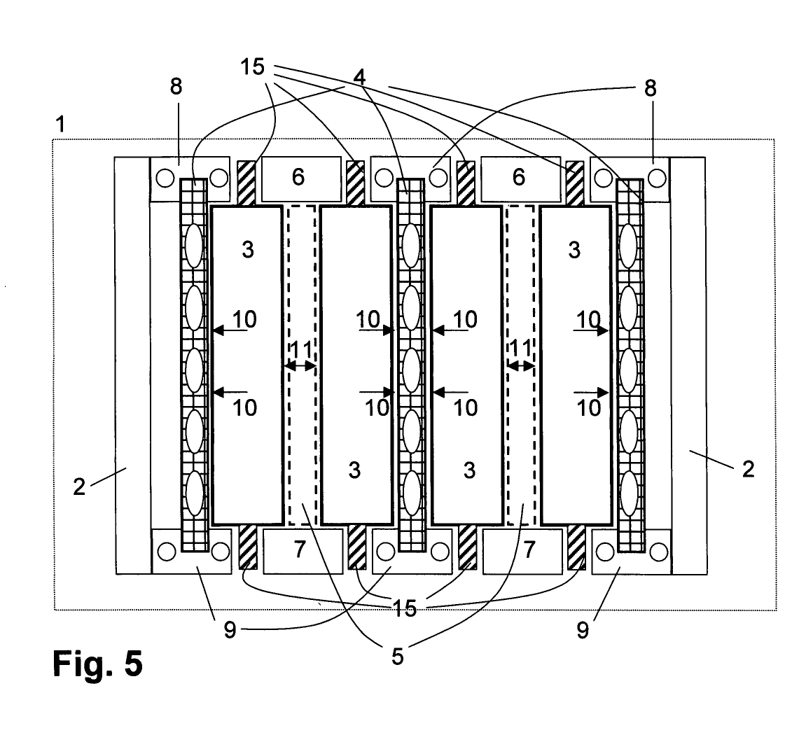

FIG. 5 shows an electrochemical energy storage device according to the invention and according to a fifth embodiment of the invention with channels in the heat conducting bodies and in the casing;

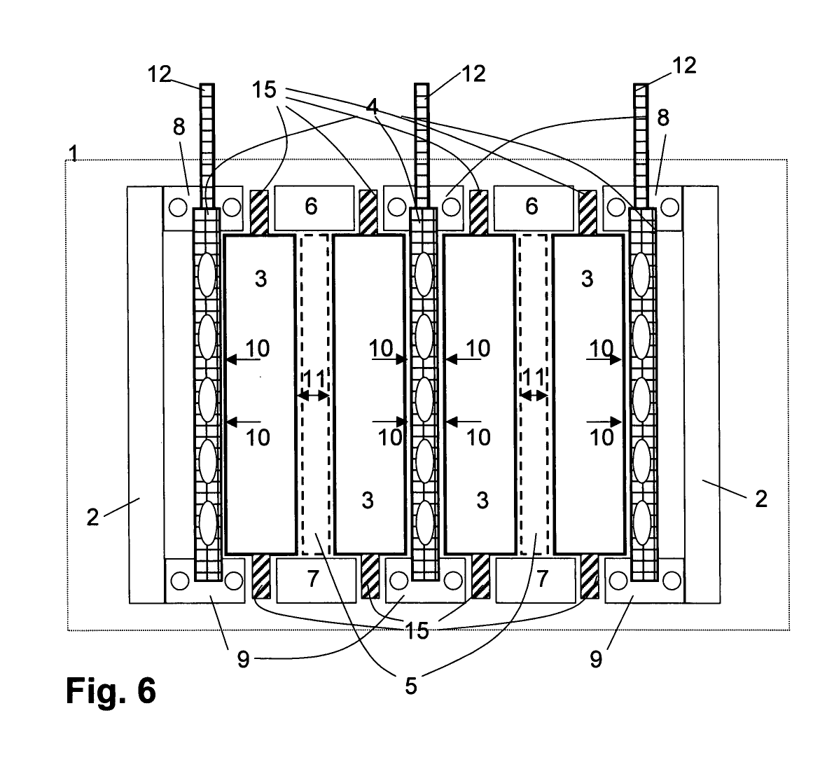

FIG. 6 shows an electrochemical energy storage device according to the invention and according to a sixth embodiment of the invention with heat exchange elements on the heat conducting bodies and with channels in the heat conducting bodies and in the casing; and

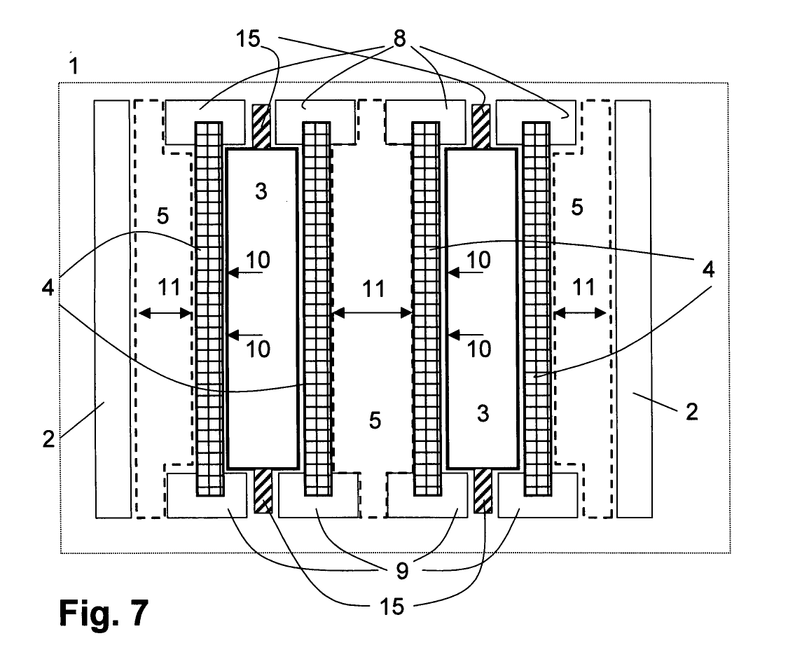

FIG. 7 shows an electrochemical energy storage device according to the invention and according to a seventh embodiment of the invention.

The electrochemical energy storage device according to the invention, has a casing 2, in which a plurality of flat galvanic cells 3 are arranged. A flat heat conducting body 4 and/or a flat elastic body 5 is arranged between two adjacent flat galvanic cells 3, respectively.

As schematically shown in FIG. 1, for example, a heat conducting body 4 and an elastic body 5 are preferably arranged on each of both major surface areas of a prismatic galvanic cell 3. With appropriate dimensioning of the distances and of the volumes of the cells and of the elastic bodies 5, it may be achieved that the elastic bodies 5 are pressed together by forces 11, which act between the contacting surface areas of the cells and the elastic bodies. By this measure, it may be achieved that surface pressing occurs at the contact surface areas of the bodies involved, namely at the contact surface areas of the heat conducting bodies 4 of the galvanic cells 3 and of the elastic bodies 5, which causes the galvanic cells 3 to be sandwiched between the heat conducting bodies 4, and thereby, causes them to be fixed.

Since each surface area of the galvanic cells 3 is in thermal contact with a heat conducting body 4, said heat conducting body 4 can dissipate the heat, generated on the contact surface areas, due to its heat conducting capacity. In case the heat conducting body 4 is additionally mechanically fixed in corresponding structures 9 of the casing, so that a shift of the heat conductng body, perpendicular to the contact surface areas may not take place, then a shift of the galvanic cells 3 in the direction perpendicular to the contact surface areas is suppressed, or at least impeded, or reduced to a minimum.

The pressure of the existing surface pressing further ensures that the galvanic cells 3 each are pressed against adjacent heat conducting bodies 4, whereby the heat transfer between the galvanic cells 3 and the heat conducting bodies 4 is improved. In case of cooling the galvanic cells 3, arrows 10 illustrate the heat flow from the galvanic cells 3 into the heat conducting bodies 4. The arrows 10 also indicate, the force with which the galvanic cells 3 are pressed towards the heat conducting bodies.

As shown in FIG. 1, the flat galvanic cells 3, the flat heat conducting bodies 4 and/or the flat elastic bodies 5 exert a force 11 upon each other that corresponds to a surface pressing at the contact surface areas. Preferably, this is achieved in that the casing which has at least one wall with a structure or with structures 8, 9, with which at least one heat conducting body 4 engages, such that said heat conducting body is not shiftable in the direction of the force 11, acting on the contact surfaces areas.

FIG. 2 shows a further preferred embodiment of the invention, in which the heat conducting bodies are in thermally conductive connection with heat exchange elements 12, which protrude from the casing 2. Such heat exchange elements 12 may, preferably, be made in form of cooling surface areas or of cooling fins, or in a similar form. It is advantageous when said heat exchange elements 12 possibly enlarge the heat transfer surface areas of heat conducting bodies 4 with respect to a heat transfer medium, to thereby provide a most efficient heat transfer between the heat conducting bodies 4 and the environment.

Such heat exchange elements 12 and the heat conducting bodies 4 may, on the other hand, not only serve for cooling the galvanic cells 3, but also, for heating the same. In case the galvanic cells 3 are, for example, below their operating temperature, then an effective heating of these galvanic cells is possible by heating the heat conducting bodies 4, and by the heat conducting bodies 4 emitting said heat to the galvanic cells 3 via the joint contact surface areas. In this case, the heat current flows opposite to the direction as indicated by the arrows 10.

Also in this case, heat exchange elements 12 may be an advantageous embodiment, for example, in case a heat transfer medium flows around said heat exchange elements having a temperature, which is above the current temperature of the galvanic cells.

FIG. 3 shows a further preferred embodiment of the invention, in which the casing elements 8, 9 have channels 13, through which a gaseous or liquid heat transfer medium may flow. In this embodiment of the invention, a particularly good thermally conductive contact between the casing parts 8, 9 and the heat conducting bodies 4 is achieved. This is particularly advantageous, since thereby, heat flows between the galvanic elements 3 and the channels 13, through which the heat transfer medium flows, which may contribute particularly effective to the heat exchange.

FIG. 4 shows a further embodiment of the invention, in which the heat conducting bodies 4 themselves are criss-crossed by channels 14, through which a gaseous or liquid heat transfer medium may flow. In this embodiment of the invention, the casing parts 8, 9 may advantageously be realized as heat-insulating casing parts, since the heat transfer does not have occur by means of said casing parts. Another advantage of said embodiment is that the heat transfer paths between the heat sources or the heat sinks, namely the galvanic cells 3 and the heat transfer medium, are shorter compared to the other embodiments of the invention, which are shown here.

At least in those cases, in which the casing parts 8, 9 may be realized as heat-insulating casing parts, these casing parts 8, 9 may also be designed as an elastic body, since the heat transfer does not have take place via said casing parts. This allows a further improvement of the elastic storage of the electrochemical cells 3.

FIGS. 5 and 6 show combinations of previously described embodiments of the invention, which are associated with a further increased efficiency of the heat transfer between the galvanic cells 3 and the environment.

FIG. 7 shows a further embodiment of the invention in a schematic way, in which the electrochemical (“galvanic”) cells 3 are contacted on both sides by heat conducting bodies 4, whereby the effectiveness of the cooling and/or of the heating of these cells can be further increased. Surface pressing may preferably be generated, as realized, by elastic bodies 5 pressed between these aggregates of one cell 3 and two heat conducting bodies 4, respectively.

Depending on the embodiment of the invention, the design measures as shown, each different advantages. They contribute in different ways to achieving the objective that all forces possibly occuring in a vehicle are transferred from the galvanic cells 3 to the battery casing 2. Through this transfer of forces, it may be ensured that no vibrations of the galvanic cells 3 occur, or turt us relative movements of the galvanic cells 3 and the battery casing 2 occur.

Preferably, thereby, more cells 3 are arranged between heat conducting plates, than heat conducting bodies 4 or fiber composite plates, having a preset surface pressing between the cell surface areas and the heat conducting plates, which serve, at the same time, as mounting plates, when being engaged in the structures 8, 9 of the casing. The mounting plates 4 thereby transfer orthogonal mass-forces in the direction of the arrows 10 from the surface of the electrode packet to an intermediate profile 8, 9, or directly to the battery casing. The mounting plates also contribute to the heat conduction from the surface of the galvanic cells 3 to the environment, for example, to a cooling system, acting as heat conducting body 4.

Preferably, the mounting plates are made to correspond to each other such that a transfer of the mass-forces occurs without tolerances and without a relative movement between the galvanic cell and the mounting plate. Possible embodiments thereof are screw connections between the mounting plate and the battery casing or between the mounting plate and an intermediate profile 8, 9.

Another possibility is to provide a notch in the battery casing or in an intermediate profile, such that the mounting plate engages in said notch. Alternatively, mounting plate and intermediate profile may also preferably be made of one piece and then bolted to the battery casing. In this case, a mounting plate with a surrounding frame may be used. Alternatively, the mounting plate and the battery casing can also be preferably, made of one piece. An additional possibility to implement the invention is to connet the base plate, the mounting plate and/or the intermediate profile with the side walls or the lid of the battery casing with one supporting structure having high stiffness vis-à-vis buckling and bending.

In the respective embodiments of the invention, the intermediate profile also transmits horizontal and vertical mass-forces from the front sides of the galvanic cells 3 to the battery casing 2.

In case the thickness of the galvanic cells is subject to changes during the operation, which is, for example, the case for lithium-ion flat cells, said change of the thickness can be compensated for by a deformation of the elastic body 5 between two galvanic cells, respectively.

In some embodiments of the invention, the channels provided are suitable for the through-flow of a heat transfer medium for improving the effectiveness of cooling or of heating of the electrical energy storage device. Preferably, a liquid cooling is used, which should be selected to ensure the maximum acceptable operating temperature of the galvanic cells. Such cooling of the galvanic cells ensures, that both in the vehicle as driven and also in the vehicle as at rest, and, in particular, also, when charging the electrochemical energy storage device, the resulting heat of the cells will be safely dissipated to the environment or used for heating the vehicle, by means of directing heat the interior of the vehicle.

Such a liquid cooling may preferably be realized by means of a coolant circuit and a heat exchanger, connected thereto. Alternatively, a coolant circuit or a refrigerant circuit, with an evaporator, a condenser, and a compressor may also be realized. A combination of both circuits is also possible and, depending on the purpose of use, may be advantageous.

An electrochemical energy storage device may, preferably, also be used as a heat storage, which may be specifically used in the cycle of driving, idling, and charging mode, to maximize the reach and to minimize the energy consumption of an operating vehicle. To achieve this, it is advantageous, when the electrochemical energy storage device is primarily cooled during the charging process.

According to another preferred embodiment of the present invention, which may also be combined with other embodiments, latent heat storage devices are arranged in the spaces between adjacent storage cells. Said latent heat storage devices may also be identical with the elastic bodies, or they may be integrated into said elastic bodies. They may also be integrated into said heat conducting body. Preferably, they extend beyond the entire length and width of said spaces, between the cells and preferably, contain a substance whose melting heat is somewhat above the operating temperature of the battery. The melting heat of such a material may be used for cooling the electrochemical energy storage device by uptaking the heat loss of the storage cells. Additionally or alternatively to the integrated latent heat storage devices, heat exchange with an externally installed heat storage device may also occur.

An essential advantage of embodiments of the invention, in which the heat conducting bodies extend beyond the full length and width of the galvanic cells, is that the heat dissipated from the storage cells may be dissipated over the entire length and width of the galvanic cell, which reduces the vertical and horizontal temperature gradients at the surface and in the interior of the storage cells.

When using heat exchangers, it is particularly advantageous to arrange the heat exchangers such that all galvanic cells have essentially the same distance to the heat exchanger. Thereby, it may be ensured, that at least an approximately uniform temperature distribution between the galvanic cells is provided. It is particularly advantageous to equip an electrochemical energy storage device according to the invention with a combined system comprising integrated cooling and a separate heat exchanger and integrated latent heat storage devices. If necessary, electrically powered heating elements may also be integrated in the heat exchangers to ensure, in all cases, to maintain the equilibrium temperature of the electrochemical energy storage device.

In order to air condition the passenger compartment of the vehicle, it is advantageous to provide a refrigerant circuit, which preferably comprises an evaporator, an expansion valve, a collector or a drier, a condenser, and preferably, an electrically driven compressor.

In order to use the heat capacity of the electrochemical energy storage device as efficiently as possible for the uptake of the waste heat, as generated in the electrochemical energy storage device during the charging or discharging process, it is advantageous and therefore preferred, to control the cooling of the battery such that, at the end of the discharging process, the acceptable maximum temperature of the electrochemical energy storage device is just achieved. Thereby, it is possible, to store the maximum possible portion of the waste energy, which is generated during the charging and discharging process via the heat capacity of the electrochemical energy storage device.

To achieve this, it is generally advantageous, to maintain the target temperatur value for controlling the battery heating, to be as low as possible, i.e., preferably, somewhat above the minimum acceptable operating temperature. Thereby, it is often particularly beneficial in regard the energy balance of the electrochemical energy storage device, if the heat capacity is, at first, fully utilized, before heat energy is dissipated through a cooling of the electrochemical energy storage device.

Based on the figures, the following reference numerals are used in connection with the description of the present invention:

1 electrochemical energy storage device

2 casing

3 electrochemical (galvanic) cell

4 heat conducting body

5 elastic body

6, 7, 8, 9 casing parts, structures on or in the casing

10 arrows in the direction of the force or, respectively, of the heat flow

11 arrows in direction of the force

12 heat exchange elements

13 channels in the casing or, respectively, in the intermediate profiles

14 channels in the heat conducting bodies

15 conductors, electrical contacts for connection

1-12. (canceled)

13. An electrochemical energy storage device, comprising:
a casing in which a plurality of flat galvanic cells is arranged;
one or more flat heat conducting body and/or one or more flat elastic body, the flat heat conducting body and/or a flat elastic body being arranged between two adjacent flat galvanic cells, respectively;
wherein the casing includes at least one wall with at least one elastic structure configured to engage a heat conducting body.

14. The electrochemical energy storage device according to claim 13, wherein the flat galvanic cells, the one or more flat heat conducting body and/or the one or more flat elastic body exert a force, corresponding to a surface pressing, upon each other, at a contact surface area.

15. The electrochemical energy storage device according to claim 14, wherein the casing includes at least one wall with a at least one structure configured to engage the one or more heat conducting body, such that the one or more heat conducting body cannot be shifted in the direction of the force acting on the contact surface area.

16. The electrochemical energy storage device according to claim 13, wherein the one or more flat heat conducting body is in connection with one or more heat exchange element protruding from the casing in a heat conductive manner.

17. The electrochemical energy storage device according to claim 13, wherein the one or more flat heat conducting body is in connection, in a heat conductive manner, with one or more casing part including one or more channel configured to receive a flow of a gaseous or liquid heat transfer medium.

18. The electrochemical energy storage device according to claim 13, wherein the one or more flat heat conducting body includes one or more channel configured to receive a flow of a gaseous or liquid heat transfer medium.

19. A method, comprising:
cooling or heating an electrochemical energy storage device with a casing in which a plurality of flat galvanic cells is arranged, wherein one or more flat heat conducting body and/or one or more flat elastic body is arranged between two adjacent flat galvanic cells, respectively, such that the one ore more one heat conducting body engages with one or more elastic structure of at least one wall of the casing.

20. The method according to claim 19, wherein the flat galvanic cells, the one or more flat heat conducting body and/or the one or more flat elastic body exert a force upon each other, corresponding to a surface pressing, at a contact surface area.

21. The method according to claim 20, wherein the casing includes at least one wall that includes at least one structure configured to engage with the one or more heat conducting body such that the one or more heat conducting body cannot be shifted in the direction of the force acting on the contact surface area.

22. The method according to claim 19, wherein the one or more heat conducting body is in contact, in a heat conductive manner, with one or more heat exchange element protruding from the casing.

23. The method according to claim 19, wherein the one or more heat conducting body is in contact, in a heat conductive manner, with one or more casing part including one or more channel configured to receive a flow of a gaseous or liquid heat transfer medium.

24. The method according to claim 19, wherein the one or more heat conducting body includes one or more channel configured to receive a flow of a gaseous or a liquid heat transfer medium.
